(19) United States
(12) Patent Application Publication
(10) Pub. No.: US 2015/0294429 A1
(43) Pub. Date: Oct. 15, 2015

(54) System and Method for Assessing Athlete Recruiting Compatibility

(71) Applicant: Timothy Williams, Prescott, AZ (US)

(72) Inventor: Timothy Williams, Prescott, AZ (US)

(21) Appl. No.: 14/251,203

(22) Filed: Apr. 11, 2014

(51) Int. Cl. G06Q 50/20; G06Q 10/10; G06Q 50/00

(52) U.S. Cl. CPC G06Q 50/2053; G06Q 50/01; G06Q 10/10

(57) ABSTRACT

A method and system for assessing compatibility between athletes and coaches. The system/method efficiently assesses one or more candidate athlete's athletic/academic/social/financial attributes, preferences and requirements, assesses one or more recruiting coach's corresponding preferences and requirements of a candidate athlete, and uses such information to quantitatively determine the degree to which such particular candidate athletes and particular recruiting coaches are a compatible recruiting match. The method and system provides for means for displaying a hierarchy of compatible athletes and coaches in a manner that provides for efficient evaluation of recruiting matches. The system/method is intended to assist in reducing the number of instances in which athletes are recruited to colleges for which they incompatible, either due to the athlete's preferences, or due to the college coach's preferences. The system/method is also intended to maximize the efficiency of the recruiting process by reducing the likelihood that incompatible athletes/coaches will pursue one another.

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### BACKGROUND OF THE INVENTION

1. Technical Field of the Invention

The invention relates generally to a system and method for assessing and evaluating compatibility between athletes, coaches and other persons, and in particular, to a system and method for accurately and efficiently assessing one or more candidate athlete's athletic/academic/social/financial attributes, preferences and requirements, assessing one or more recruiting coach's corresponding preferences and requirements of a candidate athlete, and using such attributes, preferences and requirements to quantitatively determine the degree to which such particular candidate athletes and particular recruiting coaches are a compatible recruiting match.

2. Description of the Related Art

The college recruiting process is typically an arduous process in which college coaches and recruiters evaluate numerous potential high school and junior college athletes, searching for potential college-level student-athletes that possess the optimum combination of desired attributes. The types of desired attributes sought in a potential athlete recruit will depend on the coach, the sport for which the athlete is being recruited, and the particular team position to be filled if a team sport. Coaches and recruiters often seek athletes having not only certain physical/athletic attributes, but also attributes relating to academics, type of team experience, as well as difficult to quantify intangibles such as leadership and whether the athlete is considered “coachable.”

In contrast, a high school or junior college athlete seeks not only to simply be recruited onto a team, but he or she also typically desires to find a college and a coach that is a good “fit” (also referred to herein as “compatibility”). Athletes looking for a college and coach that will likely be compatible with them often consider critical issues such as, for example, the financial requirements in order to attend the college, whether a scholarship can be offered to the athlete, whether the school is religious, whether the school offers an ROTC program, and whether the college is public or private. Like coaches, athletes also consider certain intangible attributes in a coach and college when considering whether such coach/college would likely be a compatible match. Such intangible attributes considered by an athlete may include, for example, the coaching style of the coach, the type of team play exhibited by the coach's team, and the overall sports atmosphere at the coach's college.

In many cases, assessments made by both coaches and athletes of each other with respect to the one or more of the foregoing attributes under consideration are not formed in view of objective criteria. Both coaches and athletes have difficulty in evaluating whether each other are compatible candidates, especially with respect to many of the intangibles qualities discussed above. Such difficulty often arises due to a lack of an efficient process by which coaches and athletes can both obtain information regarding the desired attributes of potential coaches/athletes, and then use such information to objectively evaluate the degree to which a particular athlete is compatible with a particular coach/college, and vice versa.

Accordingly, there is a need in the prior art for a system and method by which athletes and coaches can efficiently obtain information from one another regarding their respective tangible and intangible attributes, and then quantitatively analyze such information to determine the degree to which they are likely to be compatible.

### BRIEF DESCRIPTION OF THE SEVERAL VIEWS OF THE DRAWINGS

A more complete understanding of the invention may be had by reference to the following detailed description of various embodiments when taken in conjunction with the accompanying drawings, wherein:

FIG. 1 illustrates a preferred exemplary overview of a process for assessing an athlete's attributes, preferences and requirements, and evaluating such athlete's recruiting compatibility with one or more coaches or athletic programs according to one embodiment of the present invention;

FIG. 2 illustrates a preferred exemplary overview of a process for assessing a coach's attributes, preferences and requirements, and evaluating such coach's recruiting compatibility with one or more athletes according to one embodiment of the present invention;

FIG. 3 illustrates a preferred exemplary process for evaluating the recruiting compatibility of a particular athlete and a particular coach according to one embodiment of the present invention;

FIG. 4 illustrates a preferred exemplary block diagram of a system for evaluating the recruiting compatibility of a particular athlete and coach according to one embodiment of the present invention;

FIG. 5 illustrates a preferred exemplary block diagram of a system on which exemplary processes of the present disclosure can be executed according to one embodiment of the present invention;

FIG. 6 illustrates an exemplary web browser GUI showing an athlete's profile (as seen by athlete) as generated according to one embodiment of the present invention;

FIG. 7 illustrates an exemplary web browser GUI showing an athlete's school compatibility matches (as seen by athlete) for a particular school division as generated according to one embodiment of the present invention;

FIG. 8 illustrates an exemplary web browser GUI showing an athlete's matching criteria (as seen by athlete) associated with athletic capabilities for a particular school as generated according to one embodiment of the present invention;

FIG. 9 illustrates an exemplary web browser GUI (as seen by coach) showing an coach's highest matching athletes for a particular grade classification, sorted by position and player ranking, as generated according to one embodiment of the present invention; and

FIG. 10 illustrates an exemplary web browser GUI (as seen by coach) showing a communication dialog through which a coach may communicate with a particular athlete, as generated according to one embodiment of the present invention.

Where used in the various figures of the drawings, the same reference numerals designate the same or similar parts. All figures are drawn for ease of explanation of the basic teachings of the invention only; the extensions of the figures with respect to number, position, relationship, and dimensions of the parts to form the preferred embodiment will either be explained or will be within the skill of persons of ordinary skill in the art after the following teachings of the present invention have been read and understood. Further, the exact dimensions and dimensional proportions to conform to specific width, length, and similar requirements will likewise be within the skill of the art after the following teachings of the invention have been read and understood.

### DETAILED DESCRIPTION OF THE DRAWINGS

Several embodiments of Applicant's invention will now be described with reference to the drawings. In most cases, the items being discussed below correlate to a figure and a reference numeral appearing on the attached drawings.

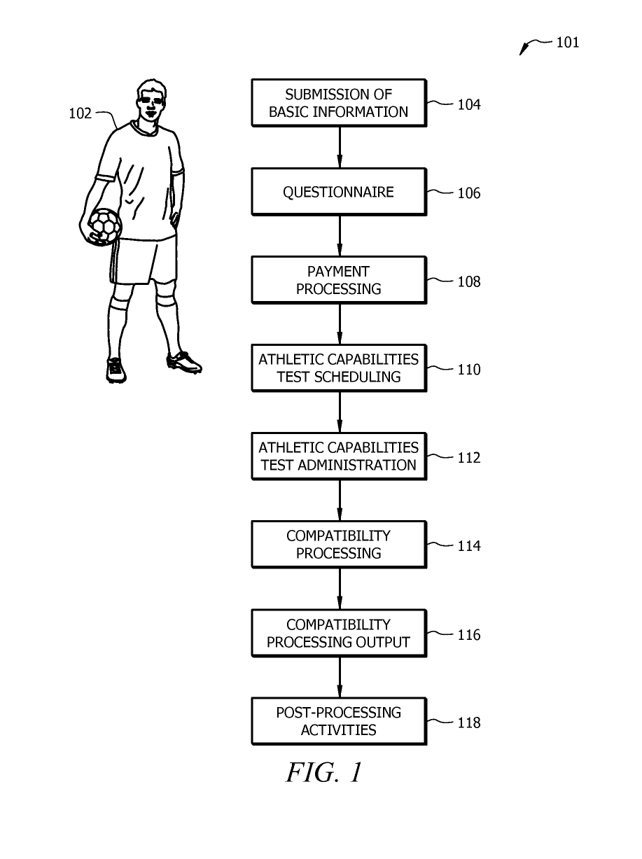

Referring to FIG. 1, a preferred exemplary overview of a process (101) for assessing an athlete's attributes, preferences and requirements, and evaluating such athlete's recruiting compatibility with one or more coaches or athletic programs according to one embodiment of the present invention. Embodiments of the present invention are intended to provide athletes and coaches with enhanced processes and systems for aiding in the recruiting process, thereby enabling athletes and coaches to find the most compatible match for possible recruitment. One intended user of the systems and processes disclosed herein is a high school student athlete (102) engaged in one or more sports activities. More specifically, high school athletes who desire to be recruited into a college level athletic program. Similarly, college athletes desiring to be recruited into another college's athletic program (by transfer) are also included in the intended class of typical users of the systems/processes disclosed herein.

However, it should be noted that persons other than athletes may use and benefit from the systems and processes taught herein. In other words, the systems and processes taught herein are by no means intended to be limited to athlete recruiting, but rather may be applied to any number of circumstances in which persons seek to assess and evaluate their respective attributes, preferences and requirements to evaluate compatibility. By way of one example, persons seeking employment and persons seeking to recruit such job seekers may utilize the underlying systems and processes in alternate embodiments of the present invention to assess a potential employee's attributes, preferences and requirements.

According to the particular exemplary embodiments disclosed herein, processes and systems corresponding to recruiting compatibility between a soccer athlete and a soccer coach (or soccer program) are described. While embodiments directed to the recruiting associated with the sport of soccer (also known in some countries as “football”), Applicant's invention may also be directed to recruiting associated with any number of various other sports through the use of alternate embodiments that utilize the underlying concepts taught herein.

As discussed in further detail below, an athlete will be provided with access to a secure web application via a web browser, allowing the athlete to initiate the process of evaluating his or her recruiting compatibility with one or more coaches and athletic programs. The athlete must initially create an account with a provider of the systems and processes discussed herein, allowing the athlete to gain access to the system via a secure authentication process requiring identifying information such as, for example, a username and password. Once an athlete establishes such identifying information, he or she may login and logout of the provider's system at will. Assuming that financial obligations between the athlete and the provider are met (discussed further below), all changes made to an athlete's profile by the athlete will be saved for later access by the athlete.

Upon initial access to the system, the athlete will be prompted to enter certain basic information (104) relating to the athlete. Such basic information will preferably include the athlete's name, grade level, sport(s) played, location by city and state, gender and email address. Other information may be requested from the athlete in other alternate embodiments of the invention. Following entry of an athlete's basic information, the athlete will be required to submit responses to multiple questions (106) (“questionnaire”), intended to probe an athlete as to wide variety of information concerning the athlete, as well as an athlete's preferences and requirements in an athletic program.

By way of example, an athlete will preferably be queried as to the athlete's preferences for the geographic location (city and state) of colleges where the athlete would be willing to attend, the degree programs the athlete seeks from a college (preferably, the athlete will be required to select five degree programs he or she seeks to earn in college), whether the athlete seeks to attend a college that is affiliated with a religion (if so, what type of religion), whether the athlete desires to attend a college hosting an ROTC program (and if so, what military branches the athlete may join in such an ROTC program), and whether the athlete finds it acceptable to attend a junior college.

The athlete will also be queried as to his or her involvement in the particular sport in which the athlete seeks recruitment. For example, the athlete will be required to provide their position played (an athlete may select up to three positions for consideration), the name of any teams on which the athlete played, the contact information (name, email and phone number of coach) associated with the coaches of such teams, and certain statistics associated with the athlete's performance (for example, number of goals scored by athlete in previous season, number of assists by athlete in previous season, etc.). The athlete will also be required to provide information concerning his or her physical characteristics such as, for example, the athlete's height and weight, body fat percentage, wingspan, and the athlete's dominant foot and arm.

The athlete will also be required to provide certain information concerning the athlete's academic standing and any academic achievements (“academic attributes”) earned during high school. Such information concerning an athlete's academic attributes may include, for example, an athlete's class rank, grade point average (“GPA”), scores on standardized tests (such as S.A.T. and A.C.T.), whether the athlete was a member of the National Honor Society, whether the athlete was involved in student government, and whether the athlete performed any volunteer community service activities in high school (if so, the number of hours of service performed by athlete).

Next, the athlete will be required to provide information relating to his or her financial requirements regarding tuition costs. For example, the athlete will be queried as to ranges in the amounts of tuition money that an athlete (or his or her family) is expecting to be able to afford on a yearly basis. The athlete will also be queried as to whether he or she has completed and submitted a Free Application for Federal Student Aid (FAFSA).

The athlete will next be queried as to his or her preferences relating to a college athletic coach, the type of game style desired by the athlete, the type of team sought by an athlete, and the type of athletic atmosphere sought by an athlete. For example, with respect to coaching style preferred by an athlete, the athlete may choose from one of the following coaching styles: 1.) structured; 2.) disciplined; 3.) relaxed; and 4.) motivational. For example, with respect to the type of team sought by an athlete, the athlete may choose from one of the following team types: 1.) physically focused; 2.) technically focused; and 3.) tactically focused. For example, with respect to the type of game style sought by an athlete, the athlete may choose from one of the following game styles: 1.) direct; 2.) possessive; 3.) high speed; 4.) aggressive; and 5.) slowed and relaxed. For example, with respect to the type of athletic atmosphere sought by an athlete, the athlete may choose from one of the following athletic atmospheres: 1.) high pride (bleachers are typically filled); 2.) moderate pride (high spectator attendance at home games); 3.) low pride (low spectator attendance at games) and 4.) no preference regarding athletic atmosphere. The athlete will also be required to provide the names and contact information of persons who would be willing to provide a reference regarding the athlete's athletic attributes.

Following the completion of the questionnaire, the information provided by the athlete will be processed by the system to determine the athlete's partial compatibility with collegiate athletic programs (to the extent that profiles have been created by the coaches of such collegiate athletic programs) based upon the information provided by the athlete thus far in the compatibility matching process of the present invention (also known as “mock matching”). The athlete will preferably be provided with the number of collegiate athletic programs that are potential matches. The system will also preferably provide the athlete will the identity of the collegiate athletic program that is evaluated to be the athlete's third highest matching program based on the partial information provided by the athlete at this stage of the compatibility matching process. It should be noted that only collegiate athletic programs for which a coach has created a profile on the provider's system and submitted preferences/requirements to the provider (as described more fully below), will be among the potential matches for an athlete.

Next, the athlete will be offered the opportunity to enroll as a member of the provider's service, allowing for full access to the system and processes described herein. Membership may be provided to the athlete in exchange for payment, for example, of an initiation fee and thereafter, monthly subscription fees. Should the athlete decline to enroll as a member of the provider's service, the athlete will not be permitted to advance any further in the compatibility matching process, and the athlete's profile account will be deleted after a short period of time (for example, within one month). Athlete's that choose to enroll as a member of the provider's service will be required to provide the provider with payment information for processing (108). The provider will supply such payment information to a payment processing service (as described in more detail below).

In certain alternate embodiments of the invention, the service provider may provide members will other services in addition to the recruiting compatibility matching process discussed below. One example of such a service is an online training application in which the athlete is provided training guides via the web browser. The online training application would also be configured to allow the athlete to upload training data to the service provider's web based application, and further provide authorized coach's to view such training data to gauge the athlete's progress and provide coaching input.

Another example of such added online service may include an athlete diet plan in which an athlete may receive a diet prepared by a registered dietician especially for the athlete's particular sport and position. Another example of such an added service is an enhanced database storing all manner of information relating to colleges. Such a database would provide an athlete with access to a wide variety of information regarding a college and a college's athletic programs, including such information as tuition rates, demographic information, etc. Such a database could be accessible to the athlete via the coach's profile or via a search engine provided to the athlete through the web browser.

Another example of an added service to be provided by the service provider in alternate embodiments of the invention may include the capability by which an athlete may upload videos showing the athlete performing in competition, which could then be provided to coaches interested in recruiting said athlete. Other alternate embodiments may include the capability for a coach to upload videos of his or her team in competition or during practice, and a corresponding ability for an athlete to view such videos if he or she was interested in being recruiting by said coach. An even further example of such an added service is a compliance verification and organizer, which would provide a coach with the ability to manually update the number of times that they have contacted a recruit, and keep track of such communications. Such a service would enable a coach and an athletic program to ensure that they are not in violation of any rules (for example, NCAA rules) governing communications with potential recruits.

Another example of such an added service is a team builder application, which would allow a coach to keep track of the performance of current team members, and also allow the coach to rank such team members to assist with the formulation of starting line ups. The team builder application may also include a team member database in which a coach may manually input or upload information concerning a team member, providing easy access to all information concerning every team member.

Following member enrollment and entry of payment information by an athlete, the provider will transmit an electronic communication (such as email) to the athlete's high school coach (or club coach), requesting that he or she submit (via web) answers to specific questions concerning the member athlete that are supplied by the service provider. In particular, the athlete's high school coach will be requested to provide information such as a description of the type of player the athlete is, whether the athlete participates in an Olympic Development Program (“ODP”) (and if so, at what level), and the type of team on which the athlete plays (ECNL, Academy, etc.). For example, with respect to a description of the type of player the athlete is, the high school or club coach will be requested to choose only three of the following descriptors that best describe the qualities of the athlete: 1.) team player; 2.) technically strong; 3.) leader on the field; 4.) team player; 5.) goal scorer; and 6.) coachable. The high school or club coach will submit his or her answers to the provider for later use in determining the athlete's recruiting compatibility as discussed further below.

Further following member enrollment and entry of payment information by an athlete, the provider will transmit an electronic communication (such as email) to the athlete, confirming member enrollment and if necessary, requesting that the athlete login to the provider's system to fully complete the athlete's profile. Once logged into the provider's system, the athlete will be prompted to schedule a date (110) for an athletic capabilities test to be administered by the personnel associated with the provider. The athlete will select from available dates to take the athletic capabilities test, depending on the availability of the provider personnel. Once a date is selected for administration of the athletic capabilities test, the provider will email the athlete to confirm the test date and location of the test, and provide the athlete with instructions regarding how to prepare for the test.

On the date scheduled by the athlete and the provider, the provider personnel will administer (112) the athletic capabilities test in person. The physical tests administered during the athletic capabilities test will depend on the athlete's particular sport and position. For example, the following tests are examples of physical tests that would be administered to a soccer athlete playing as a midfielder:
Cardiorespiratory Tests
   “Beep” test
   One mile run
Power Tests
   Standing soccer throw
   Lateral standing medicine ball throw
   Double leg vertical jump
   Double leg horizontal jump
Agility Tests
   T-Test
   Modified box test
   5-10-5 test for horizontal speed
Speed Endurance Tests
   40 Meter run
   100 Meter run
   200 Meter run
   10-30 Meter sprint
   25 Yard shuttle run
Stabilization Endurance Tests
   Pillar holds right
   Pillar holds left
Strength Tests
   60 second push up test
   60 second pull up test
   5 rep max bench press
   5 rep max back squat

It should be noted that the foregoing athletic tests have been categorized according to the general type athletic attribute being tested. For example, the athletic test category “Cardiorespiratory” includes a “Beep” test and a timed one mile run.

The athletic tests set forth above are merely intended to serve as examples of the types of tests that may be administered on an athlete when implementing the recruiting compatibility assessments of the embodiments of the present invention. As will be appreciated by those skilled in the art, other athletic tests may be administered during the athletic capabilities test, in addition to or instead of those tests set forth above, in order to gauge the athletic capabilities of the athlete.

Following the administration of the athletic capabilities test, the athlete's performance results will be inputted into the provider's system by the service provider personnel and associated with the athlete for further use in compatibility processing (114) as further described in more detail below. After completion of the compatibility processing, the numerical matching score is outputted by the system to the athlete. The system will provide the athlete with a number of post-processing activity (118) opportunities based on the results of the compatibility processing (described in more detail below).

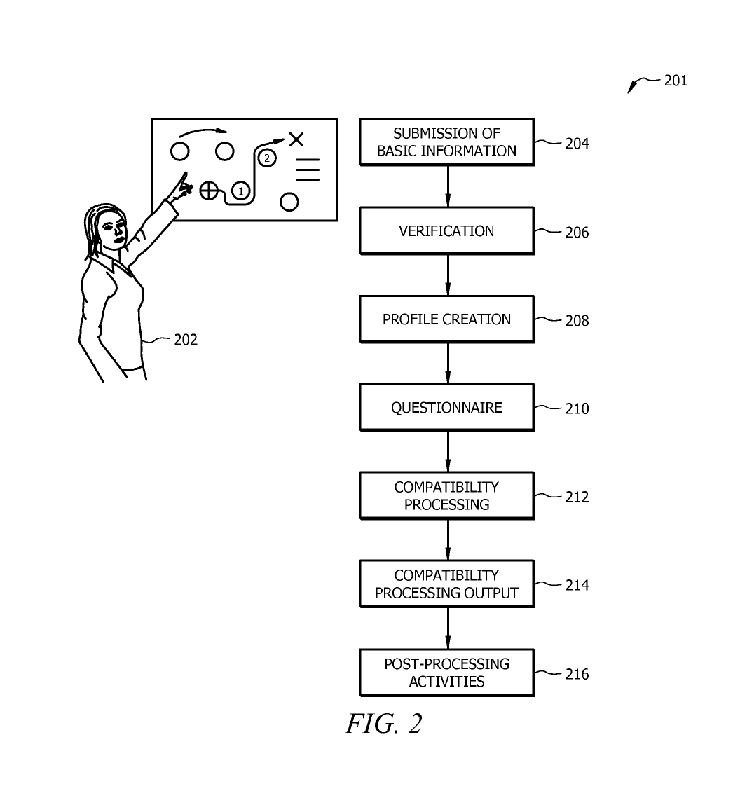

Referring now to FIG. 2, a preferred exemplary overview of a process (201) for assessing a coach's attributes, preferences and requirements, and evaluating such coach's recruiting compatibility with one or more athletes according to one embodiment of the present invention. As discussed above, another intended user of the systems and processes discussed herein are collegiate level athletic coaches and recruiters (202). Although the embodiments of the systems and processes taught herein are described in the context of coaches/recruiters and in particular, collegiate level coaches, it is contemplated that alternate embodiments of the present invention may include compatibility assessment and processing in other recruiting-like contexts including, merely by way of non-limiting examples, professional sports recruiting, job recruitment, social networking, and online dating.

Referring once again to the embodiment of the overall process illustrated in FIG. 2, a coach will gain access to a provider's system via a web based application (visually displayed on a web browser). After establishing identifying information (username and password) to initiate a web session on the provider's system, a coach will be required to enter identifying information such a name, collegiate program, and the coach's email address. The system provider will verify the identity of the coach by sending an email to the coach's athletic director, who will be asked to confirm the identity of the coach and his or her activity on the system. Failure by the athletic director to confirm the identity of the coach within a certain time period (for example, two weeks) will result in the coach's profile being deleted from the system.

Prior to identity verification by the athletic director, system provider personnel will verify that the email address supplied by the coach matches the coach's email address typically published on the website of the college where the coach claims to be employed. Following such verification, the coach will be prompted to supply the system with information needed to create a coach's profile (208). Information that must be supplied by the coach to create a profile include, for example, the following items of information:
College bio
Head coach's bio
Uploading of college logo
Contact info for other coaches in department

Next, the coach will be directed to complete a questionnaire (210), which will request further information from the coach pertaining to the college, attributes of the coach and his team, as well as the coach's preferences and requirements concerning potential athlete recruits. Information that must preferably be supplied by the coach in response to the questionnaire include, for example, the following items of information:
Name of institution
Collegiate athletic division
Public or private institution
Religious affiliation, if any
Military affiliation, if any (ROTC)
   If yes, which branches of service
Location (city & state)
Name of head coach
Contact information
Average tuition cost per year
Identity of Degree programs offered (preferably at least five)
Style of head coach (structured, disciplined, relaxed, or motivational)
Type of team (physical, technical, or tactical)
Game style (direct, possessive, high speed, slowed and relaxed, or aggressive)
Type of athletic atmosphere (high pride, moderate pride, or low pride)
College setting (urban, rural or city)
Student population size
Student/teacher ratio
Male/female ratio

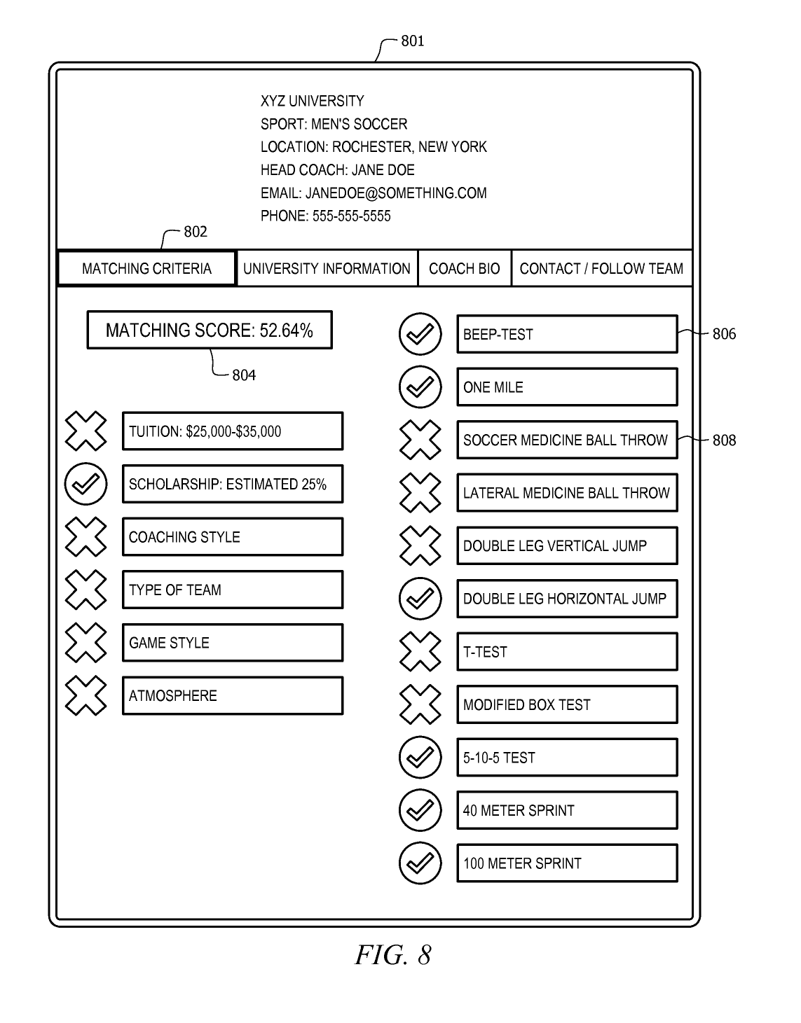

In alternate embodiments of the invention, certain information concerning the demographical information (college setting, student population, student/teacher ratio, male/female ratio, etc.) of the coach's college (where employed) may be uploaded to the service provider's web based application via, for example, an XML file. With reference to FIG. 8 (discussed in more detail below), a web browser available for display to an athlete, a browser tab labeled “University Information” will lead to a further display of such demographical and other information concerning the coach's college, thus allowing a student to learn additional potentially material information regarding such college.

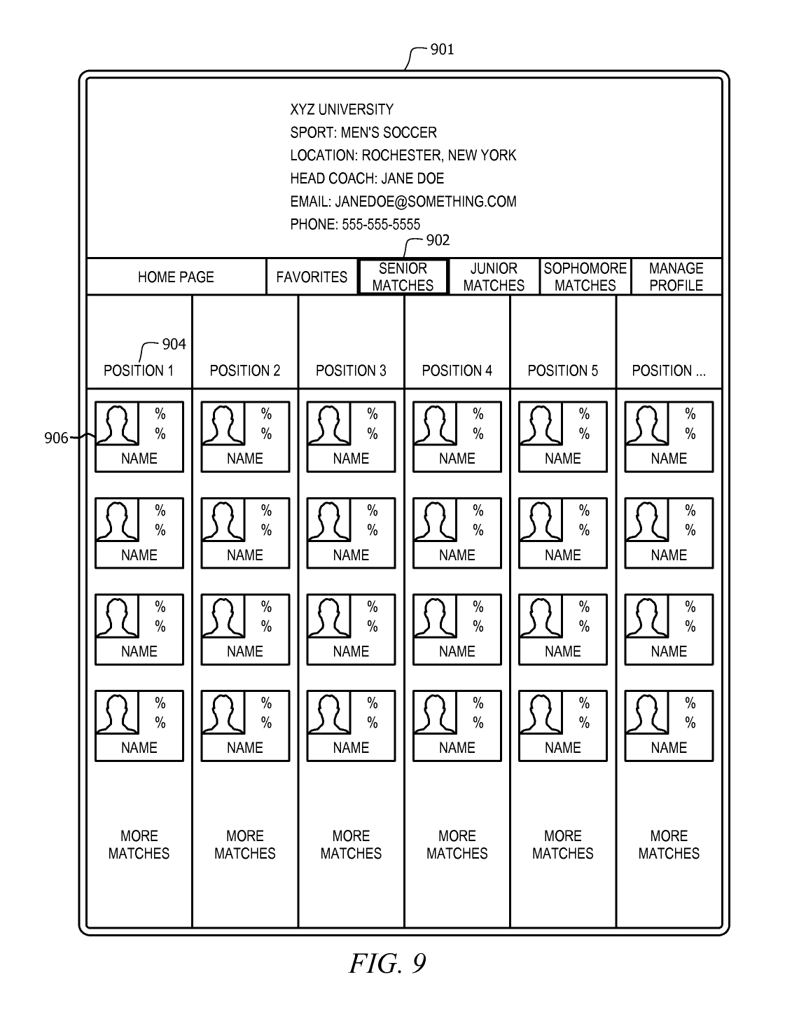

Next, for each particular recruiting class (high school seniors, juniors, and sophomores), the coach will be requested to identify (via the web browser) which team position he or she considers to be of utmost importance to recruit for in such recruiting class. The coach will then complete the questionnaire for the team position he or she indicated to be of utmost importance for the particular recruiting class. The coach will subsequently indicate the next most important team position for said recruiting class, and complete the questionnaire for such position. The coach will continue indicating the next most important team position and completing the questionnaire for as many positions as the coach wishes to complete the process. With reference to FIG. 9, an embodiment of a web browser displayed to a coach (discussed in further detail below) showing a hierarchical arrangement (players with higher matching scores are displayed higher in the arrangement) of players having matching scores, the team position indicated to be the most important by the coach, is displayed in the first column from the left of the web browser. Positions of less importance to the coach will be displayed in from left to right in order of importance (farthest right column is least important to the coach). The web based application will be configured to provide the coach with the capability of manipulating the columns displayed in the web browser such that the coach may manipulate the order of the columns if he or she determines that the importance of the team positions should be modified.

### Athletic Capability

Following position ranking by the coach, the coach will be requested to provide minimum preferred standards for each of the physical tests that are to be administered to athletes during the athletic capabilities test. The service provider may provide suggested minimum acceptable physical standards which may serve as a guide to the coach. In the event that the coach fails to enter a standard for one or more of the athletic tests to be administered, the service provider's standard for the respective test(s) will be utilized in compatibility processing. The coach will also be required to weight the importance, from 1 to 4 (1=least important, 4=most important), of each athletic test category (“section weight”). The coach will also be required to rank by importance, from 1 to 6 (1=most important, 6=least important), the overall importance of the athletic capabilities as compared to the other attributes assessed in the compatibility matching process. The term “rank,” when used herein to indicate the importance of a particular attribute of an athlete, refers to a numerical weight that may be expressed as a fractional multiplier or whole number multiplier. Likewise, the term “rank,” when used herein to indicate the importance of a particular attribute of a coach, also refers to a numerical weight that may be expressed as a fractional multiplier or whole number multiplier.

### Player Quality Description

The coach will also be required to choose what he or she considers to be the top four most important player description qualities (corresponding to the six player description qualities from which the high school/club coach chose to describe the athlete), and to rank, from 1 to 4 (1=most important, 4=least important), the importance of such four player description qualities. The coach may assign a maximum of two player description qualities as having equal rank of importance, in which case, the ranking will range from 1 to 3. The coach will also be required to rank by importance, from 1 to 6 (1=most important, 6=least important), the overall importance of the athletic capabilities as compared to the other attributes assessed in the compatibility matching process.

### Team Description

Next, the coach will be required to rank the importance, from 1 to 6 (1=most important, 6=least important), of the type of team(s) on which the athlete participated as a player. For example, the following are types of teams for which a coach may rank the importance:
ECNL/Academy team
ODP—State team
ODP—National Team
Top State Level Team
ODP—Regional Team
Secondary State Level or Other

The coach will also be required to rank by importance, from 1 to 6 (1=most important, 6=least important), the overall importance of the team description of the athlete's team(s) as compared to the other attributes assessed in the compatibility matching process.

### Academic Description

Next, the coach will be required to provide minimum acceptable academic standards for all candidate athlete recruits. For example, the coach may be required to provide a minimum acceptable G.P.A., S.A.T score, and A.C.T. score. The coach will further be required to set forth whether to take into consideration other academic achievements such as athlete participation in National Honor Society, student government, community service, and whether the athlete attended a college preparatory high school. The coach will also be required to rank by importance, from 1 to 6 (1=most important, 6=least important), the overall importance of the athlete academic standards as compared to the other attributes assessed in the compatibility matching process. Finally, the coach will be requested to submit whether the college is able to provide an athletic or academic scholarship and if so, the percentage of tuition that would be covered by such scholarship.

The coach will be requested to undertake the foregoing “questionnaire” process for each athlete position and grade classification for which compatible athletes are sought. It should be noted that certain attributes may or may not be required, depending on variables such as the position and grade classification under review. For example, S.A.T and A.C.T. scores will not be used to determine athlete compatibility for athletes in junior and sophomore grades.

After completion of the questionnaire, compatibility processing (212) will take place as described below, and a numerical matching score is outputted (214) by the system to the coach in relation to each candidate athlete having a profile in the system. As also further described below, each candidate athlete for a particular coach will be grouped according to grade classification and categorized according to position, with each athlete placed in a hierarchy based on his or her compatibility matching score for the coach. The system will provide the coach with a number of post-processing activity (216) opportunities based on the results of the compatibility processing (described in more detail below).

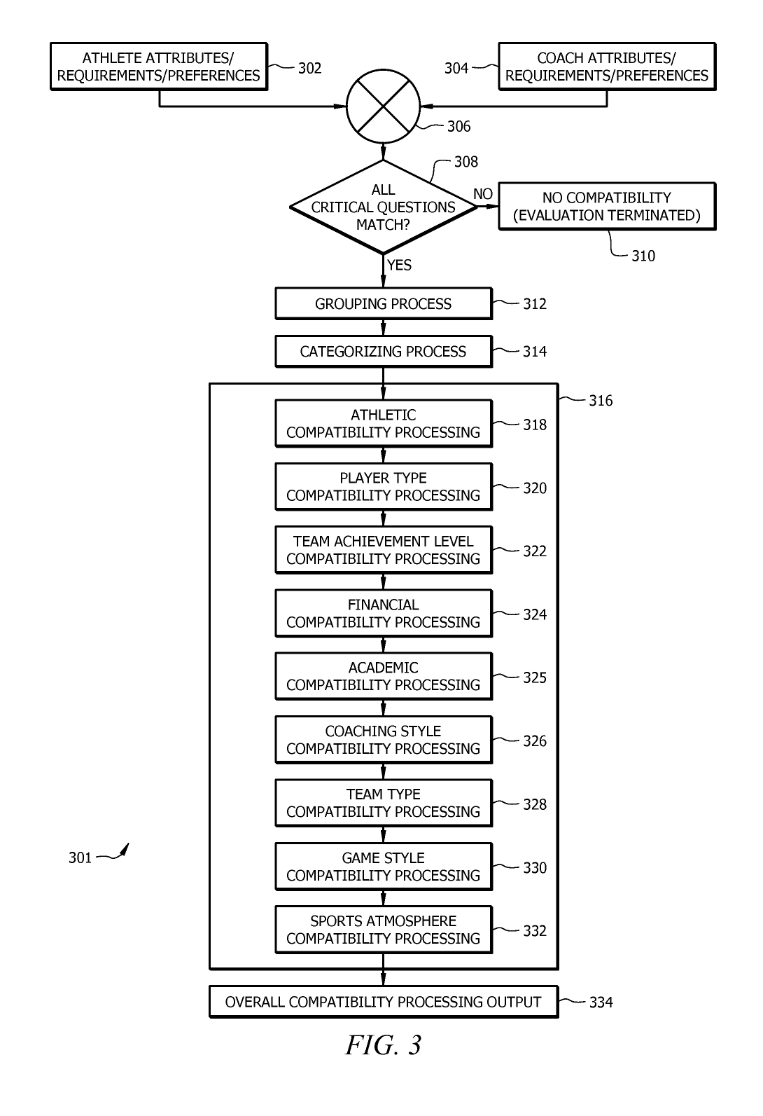

Referring now to FIG. 3, a preferred exemplary process (301) for evaluating the recruiting compatibility of a particular athlete and a particular coach according to one embodiment of the present invention. The process (301) has also been referred to as “compatibility processing” (116, 212) in the discussion above with respect to athletes and coaches. The process (301) comprises comparing attributes, preferences and requirements inputted by or otherwise associated with an athlete (302), and comparing (306) them to attributes, preferences and requirements inputted by a coach, determine a numerical matching score that correlates to the compatibility between a particular athlete and a particular coach.

Compared first are the athlete's and coach's respective answers to “critical questions” posed in the questionnaires (106, 210) submitted by the athlete and the coach. The answers to the critical questions must match (308) in order for a particular athlete to be deemed compatible with a particular coach. If one or more critical questions do not match (an athlete's answer to a critical question does not fall within a preferred range of the answer to the coach's corresponding critical question, or a coach's answer to critical question does not fall within a preferred range of the answer to the athlete's corresponding critical question), the process terminates (310) and the matching score (“overall compatibility score”) calculated is zero. It should be noted that in the event that the matching score is calculated as zero, no matching score will be reported as between the particular athlete and coach. Only matching scores greater than zero will be reported as a matching score between a particular athlete and a particular coach. Examples of critical questions in the preferred exemplary process (301) include the following:
Sport
   Sport athlete is being recruited for must match sport for which the college is recruiting.
Gender
   Gender of athlete must match desired gender sought by college
Degree programs
   Of the at least five degrees offered by the college, at least one degree must match the degree sought by the athlete
Location
   Must match geographic location sought by athlete
Military
   College offerings must match those sought by athlete
Type of institution (private, public, junior college)
   Must match type sought by athlete
Academic standards
   Athlete must meet minimum academic standards of college
Religion
   Type of college must match type of college sought by athlete

It should be noted that the foregoing list of critical questions is merely illustrative and it is contemplated that greater or lesser and different types of critical questions may be utilized in alternate embodiments of the invention. For example, although not deemed a critical question in the presently preferred embodiment of the process, alternate embodiments of the process may classify an athlete's financial requirements (and a college's corresponding tuition requirements) as a critical question.

If an athlete and coach's answers to the critical questions are all matching (the athlete's answers to critical questions all fall within a preferred range of the answers to the coach's corresponding critical questions, and the coach's answers to critical questions all fall within a preferred range of the answers to the athlete's corresponding critical questions), all athletes are automatically grouped (312) according to their high school grade classification (senior, junior, or sophomore). All athletes are further automatically categorized (413) according to player position. Each athlete may select up to three positions for consideration, and will categorized into said position categories for the purposes of compatibility processing.

Following the grouping and categorization process, further athlete attributes, preferences and requirements will be compared to the attributes, requirements and preferences provided by each particular coach. The importance placed by a coach on each particular attribute, preference and requirement, is expressed in the scoring process (316) by first determining whether a particular attribute of the athlete or coach falls within a preferred range of values (set by either the athlete or coach, depending on whether it the attribute category is assessing an attribute of the athlete or coach), and then multiply an athlete's or coach's score (may be measured on a binary scale or on a sliding numerical scale) by a numerical weighting/ranking (expressed as a fraction or whole number) that was provided by the coach in the questionnaire (210) (or in the case of measuring coach attributes, as set by the service provider). Those of ordinary skill in the art will recognize that any manner of numerical weighting (using fractional or whole number multipliers), averaging, and/or weighted averaging calculations may be utilized to calculate a matching score based on the importance assigned to attributes by a particular coach (or assigned by the service provider). What follows is an explanation of how such calculations are made in the presently preferred embodiment of the invention.

### Calculation of Athletic Compatibility Score (318)

For each athletic test administered to an athlete, a percentage (0%=fail, 100%=pass) will be assigned for the test, depending on whether the athlete met the standard (whether it falls within the preferred range indicated by the coach) set for the test by the coach (or the service provider if the coach does not set a standard score). After calculating the percentages for each athletic test, an average percentage will be calculated for each athletic test category, which will then be multiplied by the category weight (1=least important, 4=most important) assigned by the coach for that particular athletic category to arrive at an Athletic Category Weighted Score (“ACWS”). After all ACWSs are calculated, the sum of the ACWSs is divided by the sum of the category weights, to arrive at an Average Athletic Percentage (“AAP”) for a particular athlete. The Total Athletic Score (a “weighted athlete attribute value”) is calculated by multiplying the AAP by the numerical ranking (1=most important, 6=least important) of importance assigned to athletic capabilities assigned by the coach in the questionnaire (210).

### Player Type/Quality Compatibility Processing (320)

The compatibility between an athlete and a coach associated with the quality type of an athlete is dependent upon both the ranking importance to certain player qualities assigned by the coach, and the player qualities chosen by the high school or club coach to best describe the athlete. As previously mentioned, the coach is requested to weight (“CW”) in importance from 1 to 4 (1=most important, 4=least important), at least four player quality descriptions. A coach may choose to rank no more than two player types with the same rank of importance. Therefore, a coach may rank player type descriptions in the following combinations: (1,2,3,4); (1,1,2,3); (1,2,2,3); and (1,2,3,3). For each of the three player quality descriptions chosen by the high school/club coach to best describe an athlete, it will be determined whether such description matches one of the four descriptions chosen by the coach to be of importance. If such a match is made, the weight assigned by the coach (“CW”) (1=1.0; 2=0.75; 3=0.5; 4=0.25) is multiplied by 100 to obtain a Weighted Player Type Score (“WPTS”). A WTPS (WPTS) is calculated for each player type chosen by the high school/club coach to best describe the athlete. An average player type score is obtained by dividing the sum of WPTSs by the sum of the CWs. The Total Player Description Score (“weighted athlete attribute value”) is obtained by multiplying the average player type score by the numerical ranking quantity (1=most important, 6=least important) assigned by the coach to the importance of player type descriptions as compared to other attributes assessed in the compatibility matching process.

### Team Achievement Level Compatibility Processing (322)

The compatibility score for an athlete's team achievement level depends both on the types of team(s) in which the athlete participated, and the weight ascribed to such team(s) by the coach, as well as the overall importance assigned to team achievement by the coach. The coach assigns a numerical weight, from 1 to 6 (1=least important, 6=most important), to each level of team to which an athlete may be involved. Each numerical weight is assigned a fraction multiplier from 0 to 1, depending on the total number of possible descriptions (1=⅙; 2= 2/6; 3= 3/6; 4= 4/6; 5=⅚; 6=6/6). The applicable fraction multiplier is chosen by identifying the ranking of the highest ranked team in which the athlete participated. For example, if an athlete participated in an ECNL team and a ODP regional team, which were ranked by the coach as having a rank of 6 and 3, respectively, the applicable fraction multiplier to utilize is 6/6. The total score (“weighted athlete attribute value”) for team achievement level is calculated by multiplying the numerical ranking assigned by the coach to team achievement level by 100, and further multiplied by the highest applicable fraction multiplier.

### Financial Compatibility Processing (324)

Financial compatibility between and athlete and a college is assessed by comparing the financial requirements of the athlete with the financial obligations that the athlete will be faced with if he or she attends the college associated with the coach. A score of 100 is assigned if the athlete's financial requirements fall within the range of financial obligations required by the college. A score of zero is calculated is if the athlete's financial requirements fall below the range of financial obligations required by the college. In the event that the coach has indicated in the questionnaire that a scholarship can be offered to the athlete, the amount of financial obligation (tuition) required by the college will be decreased by the amount of the scholarship for the purposes of calculating whether the athlete and the college are financially compatible. A total score (“weighted athlete attribute value”) associated with financial compatibility is calculated by multiplying the resulting score (0 or 100) by the numerical ranking assigned by the coach to the overall importance of financial compatibility.

### Academic Compatibility Processing (325)

Academic compatibility is calculated by attributing a score of 100% for each academic achievement met and a score of 0% for each academic achievement not met. An average academic achievement score is calculated by finding the arithmetic mean of the scores. The average score is multiplied by the numerical ranking (1=least important, 6=most important) of importance assigned to academic achievement by the coach to arrive at a total score (“weighted athlete attribute value”) for academic compatibility.

Coaching Style Compatibility (326), Team Type Compatibility (328), Game Style Compatibility (330), and Sports Atmosphere Compatibility (332) are all preferably calculated in an identical manner. Each attribute entered by the athlete for the particular category is compared to the corresponding attribute provided by the coach. A score of 100 is assigned to the attribute if there is a match between the attributes assigned by the coach and athlete, and a score of zero is assigned if there is not a match. Each resulting score is individually multiplied by the numerical ranking (1=least important, 6=most important) of importance assigned by the athlete, to calculate a weighted coach attribute value for that particular category. In the presently preferred embodiment, a numerical ranking of 2 is automatically assigned by the system for coaching style, team type, game style and sports atmosphere.

In alternate embodiments of the invention, numerous other criteria may be incorporated into the questionnaire and the scoring process. For example, the athlete may be asked to indicate his or her preferences regarding certain demographical information pertaining to the college such as, for example, preferences concerning student population size, student/teacher ratio, male/female ratio, and the type of college setting (urban, rural, or city). The scoring process associated with such preferences would preferably be calculated in the manner set forth above with respect to coaching style, team style, game style, and sport atmosphere.

### Overall Compatibility Processing Output (334)

An overall numerical compatibility (or “matching score” or “overall compatibility score”) for a particular athlete and a particular coach is calculated by dividing the sum of the section scores (comprising weighted athlete attribute values and weighted coach attribute values for each category of attribute, depending on whether such section measures the attributes of the coach or the athlete) by the sum of the numerical ranks assigned by the coach, or assigned by the service provider in the case of sections pertaining to coach attributes, for each particular section. Those of skill in the art will appreciate that the “matching score”/“overall compatibility score” may be calculated by any of a variety of methods such as an average or weighted average of the section scores previously calculated. The calculated matching score is utilized by the coach to rank how compatible the athlete as compared to other athletes being considered for the same position(s) and the same grade level classification. Likewise, the matching score is utilized by the athlete to measure how compatible he or she is with a particular coach and/or collegiate sports program. By calculating and utilizing the matching score, the systems and processes of the present invention provide advantages over prior art methods for assessing athlete/coach compatibility in that the systems/processes disclosed herein take into account numerous attributes, preferences and requirements of both the athlete and the coach, as well as the importance of such attributes, preferences and requirements to the coach.

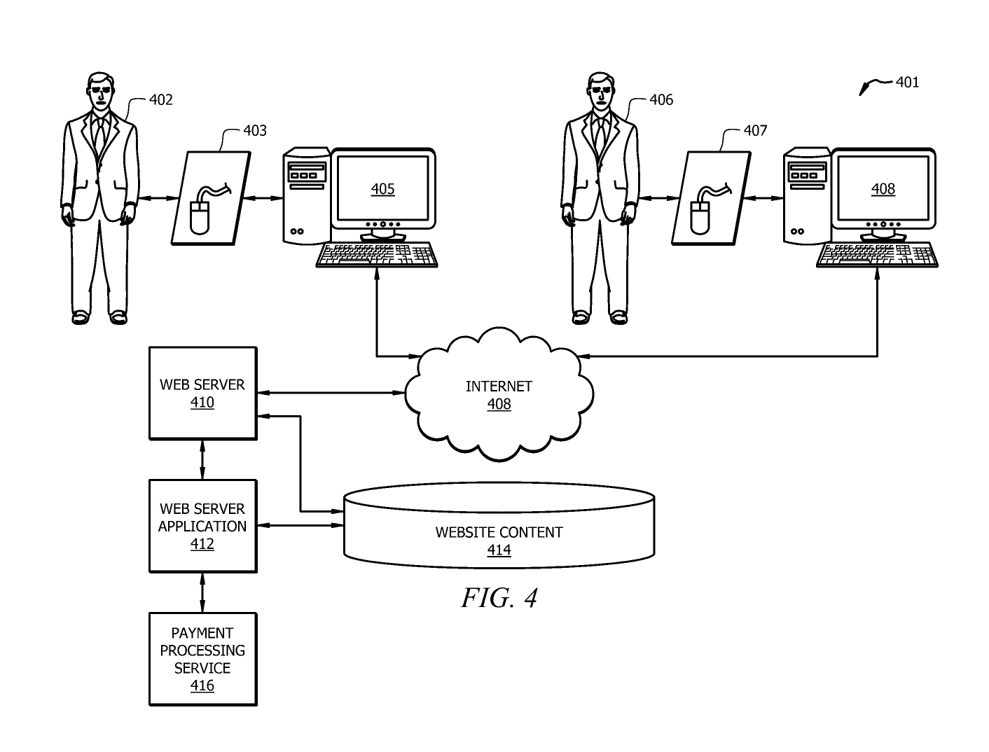

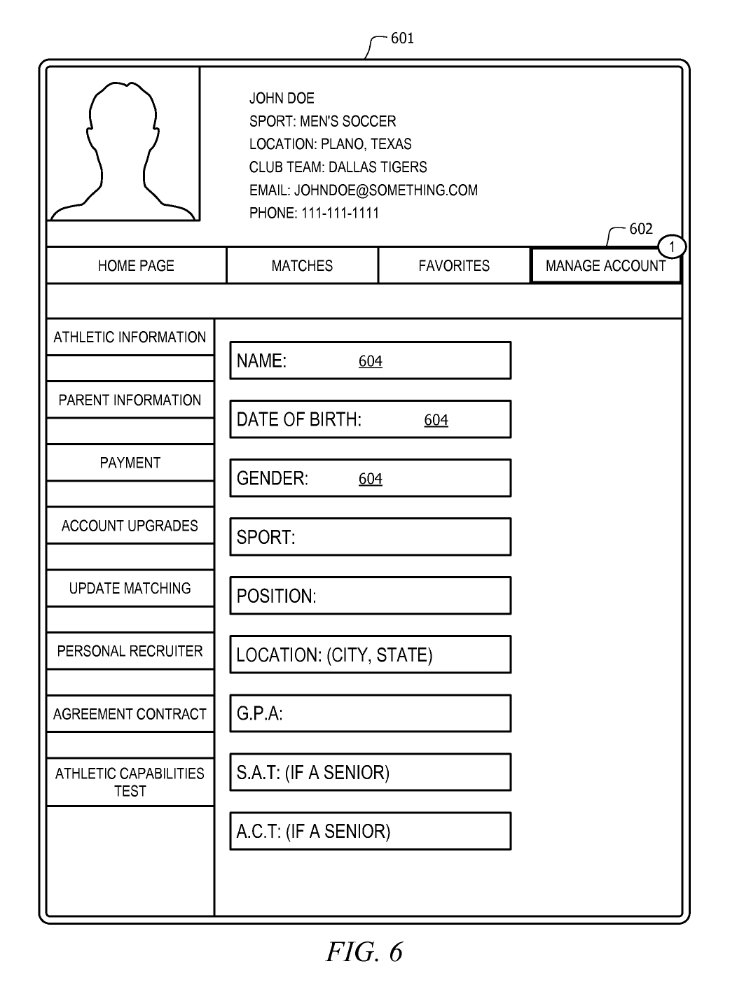

Referring now to FIG. 4, a preferred exemplary block diagram of a system for evaluating the recruiting compatibility of a particular athlete and coach according to one embodiment of the present invention. An athlete (402) may access the system by using a computing system (403) having inputs and displays (403) that enable the athlete to interact with the system. Likewise, a coach (406) may access the system by using a computing system (408) having inputs and displays (407) that enable the coach to interact with the system via a web browser displaying the type of GUIs that are shown in FIGS. 6, 7, 8, 9 and 10. The computing systems preferably communicate with the provider web server (410) via a network such as the Internet (408). A provider web server, utilizing the processes set forth above as implemented by a web server application (412), access website content (414) that includes information stored locally and/or remotely relating to the member athletes and coaches. A payment processing service (416) is in communication with the web server application, permitting the service provider to use payment information provided by an athlete, to obtain payments for member services.

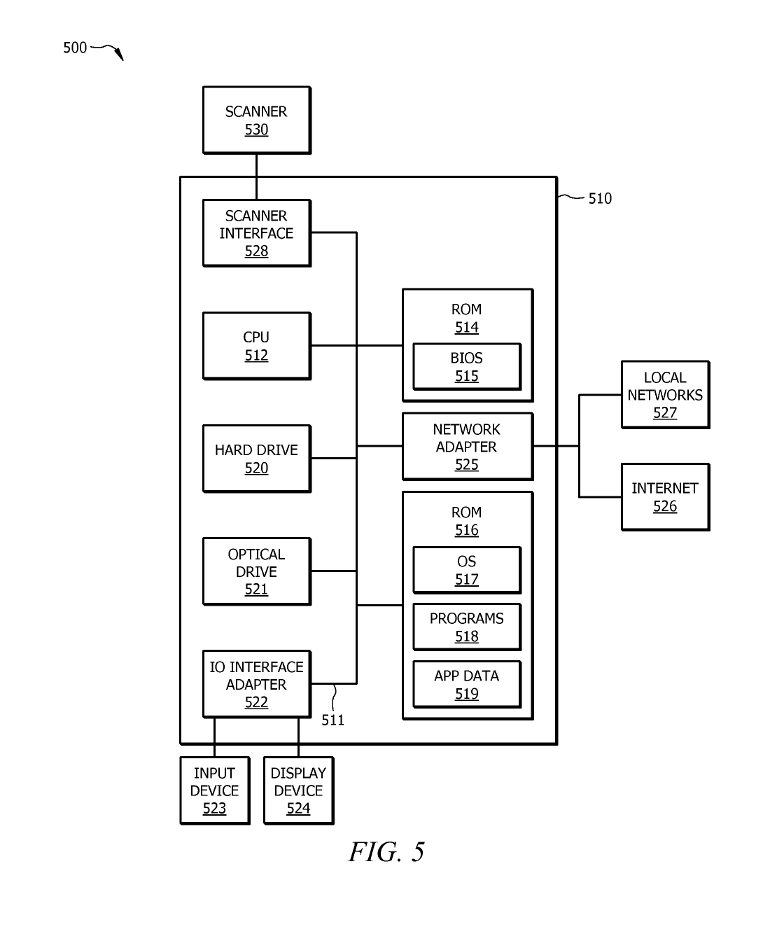

Referring now to FIG. 5, a preferred exemplary block diagram of a (500) computing system (or server) on which exemplary processes of the present disclosure can be executed according to one embodiment of the present invention. In general, the system (500) includes a computing system (510). The computing system (510) is configured to implement the compatibility matching processing operations of FIG. 1, FIG. 2 and FIG. 3. One example of the computing system (510) includes a processor unit (512), read only memory (ROM) (514), random access memory (RAM) (516), and a system bus (511) that couples various system components including the RAM (516) to the processor unit (512). The system bus (511) may be any of several types of bus structures including a memory bus or memory controller, a peripheral bus and a local bus using any of a variety of bus architectures. A basic input/output system (515) (BIOS) is stored in ROM (514). The BIOS (515) contains basic routines that help transfer information between elements within the computing system (510).

The computing system (510) can further include a hard disk drive (520) for reading from and writing to a hard disk, a magnetic disk drive (not shown) for reading from or writing to a removable magnetic disk, and/or an optical disk drive (521) for reading from or writing to a removable optical disk such as a CD ROM, DVD, or other type of optical media. The hard disk drive (520), magnetic disk drive, and optical disk drive (521) can be connected to the system bus (511) by a hard disk drive interface (not shown), a magnetic disk drive interface (not shown), and an optical drive interface (not shown), respectively. The drives and their associated computer-readable media provide nonvolatile storage of computer readable instructions, data structures, programs, and other data for the computing system (510).

Although the example environment described herein employs a hard disk drive (520), a removable magnetic disk, and removable optical disk drive (521), other types of computer-readable media capable of storing data can be used in the example system. Non-limiting examples of these other types of computer-readable mediums that can be used in the example operating environment include magnetic cassettes, flash memory cards, digital video disks, solid state disk drives, and Bernoulli cartridges.

A number of program modules may be stored on the ROM (514), RAM (516), hard disk drive (520), magnetic disk drive, or optical disk drive (521), including an operating system (517), one or more application programs (518), other program modules, and program (e.g., application) data (519).

A user may enter commands and information into the computing system (510) through input devices (523), such as a keyboard, touch screen, and/or mouse (or other pointing device). Examples of other input devices (523) may include a microphone, joystick, game pad, satellite dish, and document scanner. These and other input devices are often connected to the processing unit (512) through an I/O port interface (522) that is coupled to the system bus (511). Nevertheless, these input devices (523) also may be connected by other interfaces, such as a parallel port, game port, or a universal serial bus (USB). A monitor (524) or other type of display device is also connected to the system bus (511) via an interface, such as the IO interface (522). In addition to the display device (524), computing systems typically include other peripheral output devices (not shown), such as speakers and document printers.

The computing system (510) may operate in a networked environment using logical connections to one or more remote computers. The remote computer may be a personal computer, a server, a router, a network PC, a peer device or other common network node, and typically includes many or all of the elements described above relative to the computing system (510). In certain embodiments, the network connections can include a local area network (LAN) or a wide area network (WAN). Such networking environments are commonplace in offices, enterprise-wide computer networks, intranets, and the Internet (526).

When used in a WAN networking environment, the computing system 510 typically includes a modem, Ethernet card, or other such means for establishing communications over the wide area network, such as the Internet 526. The modem or other networking components, which may be internal or external, can be connected to the system bus 511 via a network interface or adapter 525. When used in a LAN networking environment, the computing system 510 is connected to the local network 527 through the network interface 525. In a networked environment, program modules depicted relative to the computing system 510, or portions thereof, may be stored in the remote memory storage device. It will be appreciated that the network connections shown are exemplary and other means of establishing a communications link between the computers may be used.

Referring now to FIG. 6, an exemplary web browser GUI (601) showing an athlete's profile (as seen by athlete) as generated according to one embodiment of the present invention. An athlete may use a web browser on a computing system to manage (602) his or her member account with the service provider. An athlete may also enter various identifying and other information (604) into the service provider system as required pursuant to the processes disclosed herein. The athlete may also view various other information associated with the results of compatibility processing.

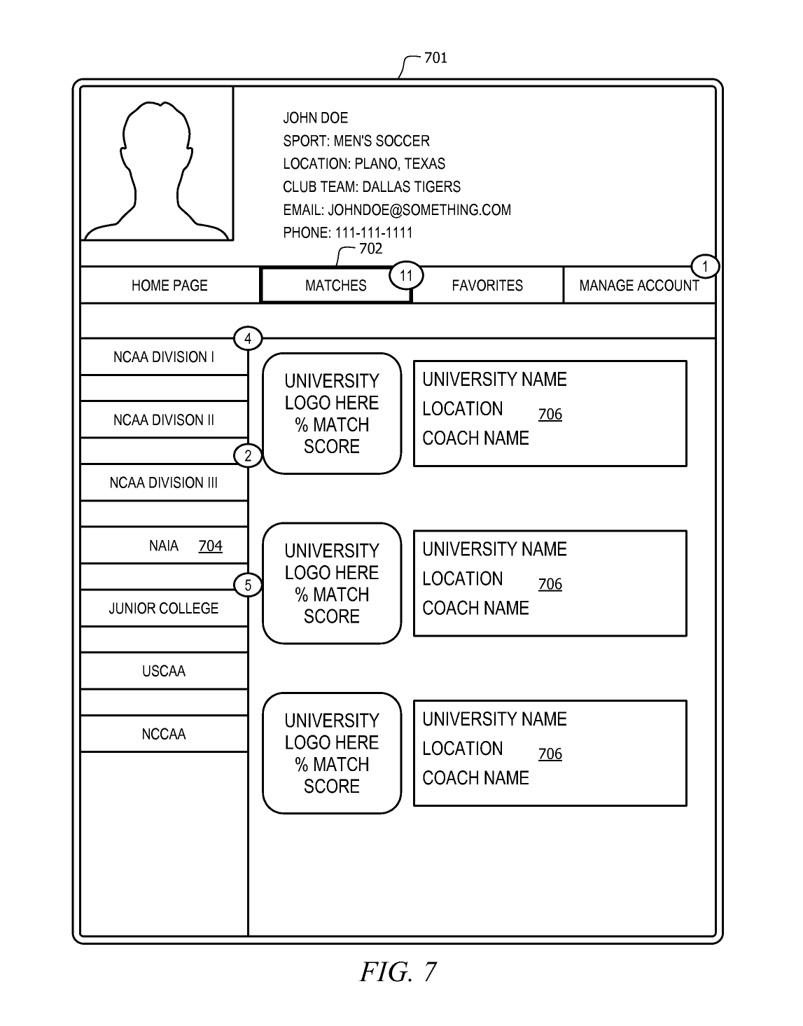

For example, and referring now to FIG. 7, an exemplary web browser GUI (701) showing an athlete's school compatibility matches (702) (as seen by athlete) for a particular school division as generated according to one embodiment of the present invention. An athlete may elect to view matching colleges (706) for particular collegiate athletic divisions such as NCAA Division I, NCAA Division II, NCAA Division III, NAIA (704), Junior Colleges, USCAA, and NCCAA.

Referring now to FIG. 8, an exemplary web browser GUI (801) showing an athlete's matching criteria (as seen by athlete) associated with athletic capabilities for a particular school as generated according to one embodiment of the present invention. Through the website provided by the service provider, an athlete may evaluate not only his or her overall matching score (804) for a particular coach/recruiter, but can also evaluate specifically how they performed in individual assessments. For example, an athlete can observe that their matching score was lowered as a result of failure on a particular athletic capabilities test (808). In contrast, an athlete can also observe which of their attributes (806) may have contributed to a higher matching score. By providing this information to athletes in such an accessible and easily understandable manner, the systems and processes of the present invention provide an advantage over prior art methods of assessing recruiting compatibility.

Referring now to FIG. 9, an exemplary web browser (901) GUI (as seen by coach) showing an coach's highest matching athletes for a particular grade classification, sorted by position and player ranking, as generated according to one embodiment of the present invention. The web browser shows how athletes (906) are comparatively ranked according to position (904) for a particular grade level classification (902). Thus, in one aspect of the compatibility system of the present invention, a coach can quickly assess athlete ranking, as well as determine which positions and/or grade levels need added recruiting attention to shore up any perceived current or future team weaknesses.

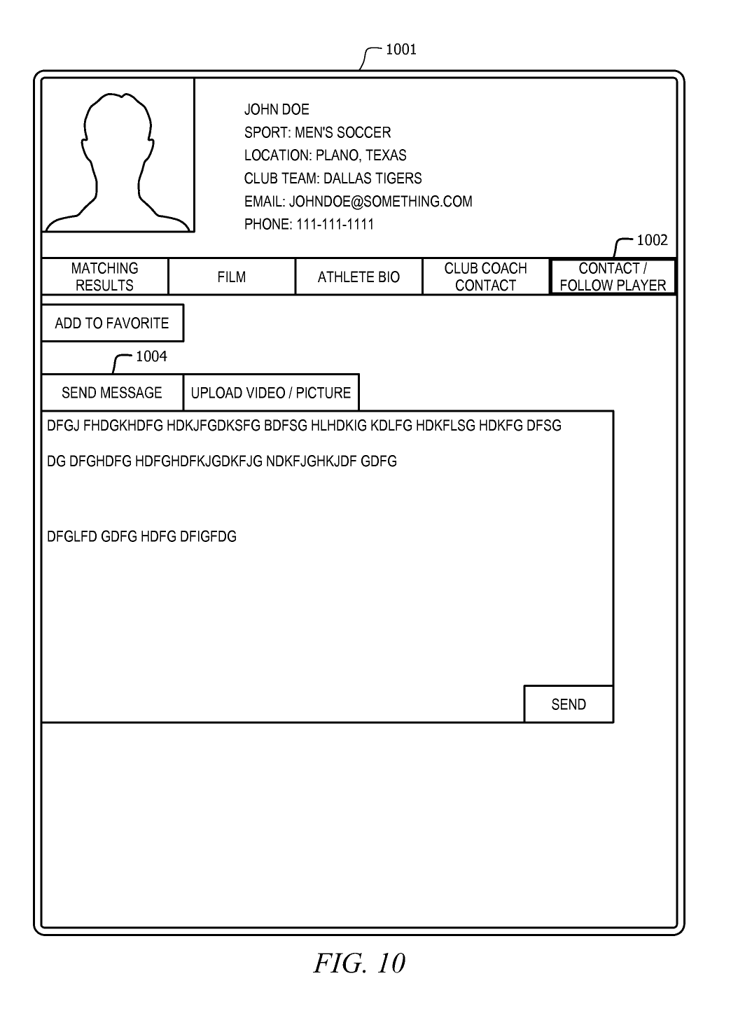

Referring now to FIG. 10, an exemplary web browser GUI (1001) (as seen by coach) showing a communication dialog (“communication platform”) by which a coach may communicate (1002) with a particular athlete, as generated according to one embodiment of the present invention. A coach may utilize the web browser to initiate (1004) electronic communications to a particular athlete that may be found to be highly compatible with the coach. By providing communication channels between an athlete and coach, the systems and processes of the present invention provide an advantage over prior art methods of conducting recruiting communications.

It should be noted that the description of the present invention has been presented for purposes of illustration and description, and is not intended to be exhaustive or limited to the invention in the form disclosed. Many modifications and variations will be apparent to those of ordinary skill in the art. The preferred embodiment appearing in the drawings was chosen and described in order to best explain the principles of the invention, the practical application, and to enable others of ordinary skill in the art to understand the invention for various embodiments with various modifications as are suited to the particular use contemplated. It will be understood by one of ordinary skill in the art that numerous variations will be possible to the disclosed embodiments without going outside the scope of the invention as disclosed in the claims. Moreover, it should be noted that uses of the phrase “the present invention” within this disclosure are not intended to limit or otherwise restrict the scope of the invention(s) disclosed and claimed by the inventor, but said phrase is merely intended to refer to certain examples of embodiments of the invention(s).

What is claimed is:

1. A method of evaluating athletic recruiting compatibility, said method at least partially executed on a tangible non-transitory computer usable medium having computer-readable program code means embodied therein for causing a computer to execute one or more steps of said method, the method comprising the steps of:
(a) creating, via a web browser operating on a computer system under control of a graphical user interface (GUI) executed with an operating system running under control of said computer system, an athlete profile of an athlete based on the athlete's answers to questions concerning the athlete's personal attributes, wherein the profile further includes the athlete's preferences concerning attributes of potential coaches;
(b) administering one or more physical tests on said athlete, the results of said one or more physical tests being included in said athlete profile;
(c) creating, via said web browser, a coach profile of a coach based on the coach's answers to questions concerning the coach's personal attributes and attributes of a college that employs said coach, wherein the profile further includes the coach's preferences concerning potential athletes, wherein said profile further includes a numerical weight assigned by said coach to one or more of said coach's preferences;
(d) wherein at least a subset of said athlete's personal attributes, athlete's preferences concerning attributes of potential coaches, and coach's preferences concerning potential athletes, are critical attributes, wherein:
if each critical attribute of an athlete does not fall within a preferred range a corresponding critical attribute of a coach, said athlete and said coach are found not to be compatible,
further wherein if each critical attribute of a coach does not fall within a preferred range of a corresponding critical attribute of an athlete, said coach and said athlete are found not to be compatible;
(e) calculating, via said computer system, weighted athlete attribute values with respect to each of said athlete's personal attributes and said results of said athlete's physical tests, said weighted athlete attribute values depending on whether such athlete's personal attributes and said results of said athlete's physical tests, fall within a preferred range of said coach's preferences corresponding to said athlete's personal attributes and said results of said athlete's physical tests, said weighted athlete attribute values being further calculated based on said numerical weight assigned by said coach;
(f) calculating, via said computer system, weighted coach attribute values with respect to each of said coach's personal attributes, said weighted coach attribute values depending on whether such coach's personal attributes fall within a preferred range of said athlete's preferences corresponding to said coach's personal attributes; and
(g) calculating and displaying, via said web browser, an overall compatibility score between said athlete and said coach based on a weighted average of said weighted coach attribute values and said weighted athlete attribute values.

2. The method of evaluating athletic recruiting compatibility according to claim 1, wherein said critical attributes include at least one of the following:
sport;
gender;
degree programs sought by athlete and offered by said college;
geographic location of said college;
availability of ROTC program at said college;
financial requirements of said college;
religious or non-religious affiliation of said college; and
private or public nature of said college.

3. The method of evaluating athletic recruiting compatibility according to claim 1, wherein said athlete's preferences concerning attributes of potential coaches include at least one of the following:
type of coaching style;
type of athletic atmosphere of said college;
type of coach's team; and
type of game style of coach's team.

4. The method of evaluating athletic recruiting compatibility according to claim 1, wherein said coach's preferences concerning potential athletes include at least one of the following:
type of player of said athlete;
athlete's physical capabilities;
type of team on which said athlete has played; and
athlete's academic achievements.

5. The method of evaluating athletic recruiting compatibility according to claim 1, wherein the type of said physical tests being administered on said athlete are at least partially selected based on a desired sport of said athlete and a desired sport position of said athlete.

6. The method of evaluating athletic recruiting compatibility according to claim 1, further comprising the step of displaying to said athlete, via said web browser, compatibility information associated with a hierarchy of a plurality of coaches, said hierarchy of said coaches depending on said overall compatibility score between said athlete and said coach.

7. The method of evaluating athletic recruiting compatibility according to claim 1, further comprising the step of displaying to said coach, via said web browser, compatibility information associated with a hierarchy of a plurality of athletes, said hierarchy of said athletes depending on said overall compatibility score between said athlete and said coach, and further depending on a grade classification of said athlete and a desired sport position of said athlete.

8. The method of evaluating athletic recruiting compatibility according to claim 1, further comprising the step of providing a communication platform, via said web browser, to said athlete and said coach if an overall compatibility score associated with them has been calculated.

9. A computer-implemented athletic recruiting compatibility processing system comprising networked computing devices executing software further comprising:
a web browser application;
wherein
said web browser application is configured to provide for the creation of an athlete profile of an athlete based on the athlete's answers to questions concerning the athlete's personal attributes, wherein the profile further includes the athlete's preferences concerning attributes of potential coaches;
said web browser application is configured to accept the results of one or more physical tests administered on said athlete, the results of said one or more physical tests being included in said athlete profile;
said web browser application is configured to provide for the creation of a coach profile of a coach based on the coach's answers to questions concerning the coach's personal characteristics and characteristics of a college that employs said coach, wherein the profile further includes the coach's preferences concerning potential athletes, wherein said profile further includes a numerical weight assigned by said coach to one or more of said coach's preferences;
wherein at least a subset of said athlete's personal attributes, athlete's preferences concerning attributes of potential coaches, and coach's preferences concerning potential athletes, are critical attributes, wherein:
if each critical attribute of an athlete does not fall within a preferred range of a corresponding critical attribute of a coach, said athlete and said coach are found not to be compatible,
further wherein if each critical attribute of a coach does not fall within a preferred range of a corresponding critical attribute of an athlete, said coach and said athlete are found not to be compatible;
wherein said computing system is configured to calculate weighted athlete attribute values with respect to each of said athlete's personal attributes and said results of said athlete's physical tests, said weighted athlete attribute values depending on whether such athlete's personal attributes and said results of said athlete's physical tests, fall within a preferred range of said coach's preferences corresponding to said athlete's personal attributes and said results of said athlete's physical tests, said weighted athlete attribute values being further calculated based on said numerical weight assigned by said coach or a standardized weight;
wherein said computing system is configured to calculate weighted coach attribute values with respect to each of said coach's personal attributes, said weighted coach attribute values depending on whether such coach's personal attributes fall within a preferred range of said athlete's preferences corresponding to said coach's personal attributes;
wherein said computing system is configured to calculate an overall compatibility score between said athlete and said coach based on a weighted average of said weighted coach attribute values and said weighted athlete attribute values; and
wherein said web browser is configured to display to said athlete and said coach, said overall compatibility score.

10. The computer-implemented athletic recruiting compatibility processing system of claim 9, wherein said critical attributes include at least one of the following:
sport;
gender;
degree programs sought by athlete and offered by said college;
geographic location of said college;
availability of ROTC program at said college;
financial requirements of said college;
religious or non-religious affiliation of said college; and
private or public nature of said college.

11. The computer-implemented athletic recruiting compatibility processing system of claim 9, wherein said athlete's preferences concerning attributes of potential coaches include at least one of the following:
type of coaching style;
type of athletic atmosphere of said college;
type of coach's team; and
type of game style of coach's team.

12. The computer-implemented athletic recruiting compatibility processing system of claim 9, wherein said coach's preferences concerning potential athletes include at least one of the following:
type of player of said athlete;
athlete's physical capabilities;
type of team on which said athlete has played; and
athlete's academic achievements.

13. The computer-implemented athletic recruiting compatibility processing system of claim 9, wherein the type of said physical tests being administered on said athlete are at least partially selected based on a desired sport of said athlete and a desired sport position of said athlete.

14. The computer-implemented athletic recruiting compatibility processing system of claim 9, wherein said web browser is configured to display to said athlete, compatibility information associated with a hierarchy of a plurality of coaches, said hierarchy of said coaches depending on said overall compatibility score between said athlete and said coach.

15. The computer-implemented athletic recruiting compatibility processing system of claim 9, wherein said web browser is configured to display to said coach, compatibility information associated with a hierarchy of a plurality of athletes, said hierarchy of said athletes depending on said overall compatibility score between said athlete and said coach, and further depending on a grade classification of said athlete and a desired sport position of said athlete.

16. The computer-implemented athletic recruiting compatibility processing system of claim 9, wherein said web browser is configured to provide a communication platform to said athlete and said coach if an overall compatibility score associated with them has been calculated.
